(19) United States
(12) Patent Application Publication
(10) Pub. No.: US 2015/0205531 A1
(43) Pub. Date: Jul. 23, 2015

(54) Adding Storage Capacity to an Object Storage System

(71) Applicant: Seagate Technology LLC, Cupertino, CA (US)

(72) Inventors: Christopher J. DeMattio, Longmont, CO (US); Craig F. Cutforth, Louisville, CO (US); Caroline W. Arnold, Broomfield, CO (US)

(73) Assignee: Seagate Technology LLC, Cupertino, CA (US)

(21) Appl. No.: 14/159,181

(22) Filed: Jan. 20, 2014

(51) Int. Cl. G06F 3/06

(52) U.S. Cl. CPC G06F 3/0608; G06F 3/0689; G06F 3/0647; G06F 3/065

(57) ABSTRACT

Apparatus and method for adding storage capacity to an object storage system. In accordance with some embodiments, a first set of data storage devices store data objects in accordance with a first map structure. A management module detects a second set of data storage devices added to the first set and, in response thereto, generates a second map structure and migrates a portion of the data objects from the first set to the second set based on the second map structure to balance the first and second sets.

### SUMMARY

Various embodiments of the present disclosure are generally directed to an apparatus and method for adding storage capacity to an object storage system, such as used in a cloud computing environment.

In some embodiments, a first set of data storage devices store data objects in accordance with a first map structure. A management module detects a second set of data storage devices added to the first set and, in response thereto, generates a second map structure and migrates a portion of the data objects from the first set to the second set based on the second map structure to balance the first and second sets.

In further embodiments, a storage controller has a processor and a memory. A plurality of storage devices is connected to the storage controller to form a storage node. The storage devices within the node are arranged into N subgroups, so that data objects are stored in the N subgroups based on a first map structure stored in the storage controller memory. A management module detects an additional plurality of storage devices that are connected to the storage controller to provide N+1 subgroups. In response, the management module migrates a portion of the data objects in each of the N subgroups to the additional plurality of storage devices, generates a second map structure to describe the data objects stored in the N+1 subgroups, and stores the second map structure in the storage controller memory.

In further embodiments, a computer implemented method includes storing data objects in a first set of data storage devices of an object storage system in accordance with a first map structure stored in a memory; connecting a second set of data storage devices to the first set; and detecting the connection of the second set to the first set, and in response thereto, generating a second map structure and migrating a portion of the data objects from the first set to the second set based on the second map structure to balance the first and second sets.

### BRIEF DESCRIPTION OF THE DRAWINGS

FIG. 1 is a functional representation of an object storage system configured and operated in accordance with various embodiments of the present disclosure.

FIG. 2 illustrates a storage controller and associated storage elements from FIG. 1 in accordance with some embodiments.

FIG. 3 shows a selected storage element from FIG. 2.

FIG. 4 is a functional representation of an exemplary architecture of the object storage system of FIG. 1.

FIG. 5 shows an exemplary format for the map (ring) structures of FIG. 4.

FIG. 6 illustrates storage of data objects (partitions) across multiple zones.

FIG. 7 shows the addition of new storage capacity to the system of FIG. 1 in accordance with some embodiments.

FIG. 8 graphically illustrates migration of data from existing storage locations to a new storage location such as in FIG. 7 to rebalance the ring structures of FIG. 4.

FIG. 9 illustrates the redistribution of data objects in FIG. 8 in accordance with some embodiments.

FIG. 10 is a functional block representation of a storage management module operable in accordance with some embodiments to detect and utilize new storage capacity in the system of FIG. 1.

FIG. 11 depicts aspects of the data migration module of FIG. 10 in accordance with some embodiments.

FIG. 12 is a STORAGE EXPANSION routine carried out by the system of FIG. 1 in accordance with some embodiments.

FIG. 13 is a graphical representation of data migrations carried out using the routine of FIG. 12 in some embodiments.

FIG. 14 is a functional representation of a storage node that uses a secondary (local data migration) path to migrate data in accordance with some embodiments.

### DETAILED DESCRIPTION

The present disclosure generally relates to the automated addition of new storage capacity to an object storage system, such as in a cloud computing environment.

Cloud computing generally refers to a network-based distributed data processing environment. Network services such as computational resources, software and/or data are made available to remote users via a wide area network, such as but not limited to the Internet. In other embodiments, the resources can be made available to local user via a localized network. A cloud computing network can be a public “available-by-subscription” service accessible by substantially any user for a fee, or a private “in-house” service operated by or for the use of one or more dedicated users.

A cloud computing network can be generally arranged as an object storage system whereby data objects (e.g., files) from users (“account holders” or simply “accounts”) are replicated and can be stored in geographically distributed storage locations or other beneficial organization structures within the system. The network is often accessed through web-based tools such as web browsers, and provides services to a user as if such services were installed locally on the user's local computer.

Attempts have been made to configure object storage systems to be massively scalable so that new storage nodes, servers, software modules, etc. can be added to the system to expand overall capabilities. An object storage system can carry out significant amounts of background overhead processing to store, replicate, migrate and rebalance the data objects stored within the system in an effort to ensure the data objects are available to the users at all times. The addition of new storage capacity to an existing object storage system can present a number of challenges with regard to ensuring system integrity, reliability and availability levels are maintained throughout the expansion process.

Accordingly, various embodiments of the present disclosure are generally directed to the addition of storage capacity to an existing storage cluster or other collective unit of an object storage system. In some embodiments, the storage cluster may be a SwiftStack cluster. As explained below, a server or proxy server is adapted to communicate with users of an object storage system over a computer network. A plurality of data storage devices store and retrieve data objects from the users. The data storage devices may be arranged into a plurality of storage nodes each having an associated storage controller. Map structures are used to associate storage entities such as the data objects with physical locations within the data storage devices.

The expansion of the existing data storage capacity of the system can be carried out to expand the storage capacity of an existing node and/or to add one or more new storage nodes to the system. A storage management module is configured to detect new storage, generate new mapping to describe the new storage, to migrate data objects within the system and to deploy the new mapping. In some embodiments, the data migration is carried out prior to the deployment of the new mapping. In other embodiments, the new mapping is deployed and the data objects are migrated to conform the system to the new mapping.

In some embodiments, a system administrator provides administrative input data to the system in conjunction with the addition of the new storage capacity to the system. The storage management module uses the existing mapping and the administrative input data to generate the new mapping and to commence transfer of at least some data objects to the new storage capacity.

In further embodiments, existing system I/O traffic with users of the system is monitored and the data migration operations are scheduled to fit within the available bandwidth of the system. In still further embodiments, secondary data migration paths are utilized to transfer data to the new storage locations.

The map structures may be referred to as rings, and the rings may be arranged as an account ring, a container ring and an object ring. The account ring provides lists of containers, or groups of data objects owned by a particular user (“account”). The container ring provides lists of data objects in each container, and the object ring provides lists of data objects mapped to their particular storage locations. Other forms of map structures can be used.

By automatically detecting and utilizing new storage, the system efficiently and effectively rebalances the system. The data objects can be quickly and efficiently migrated in the background without substantively affecting user data access operations or overhead processing within the system. In some embodiments, the detection and utilization will include some limited user input or answering of minor questions; while other embodiments will not include such an interaction.

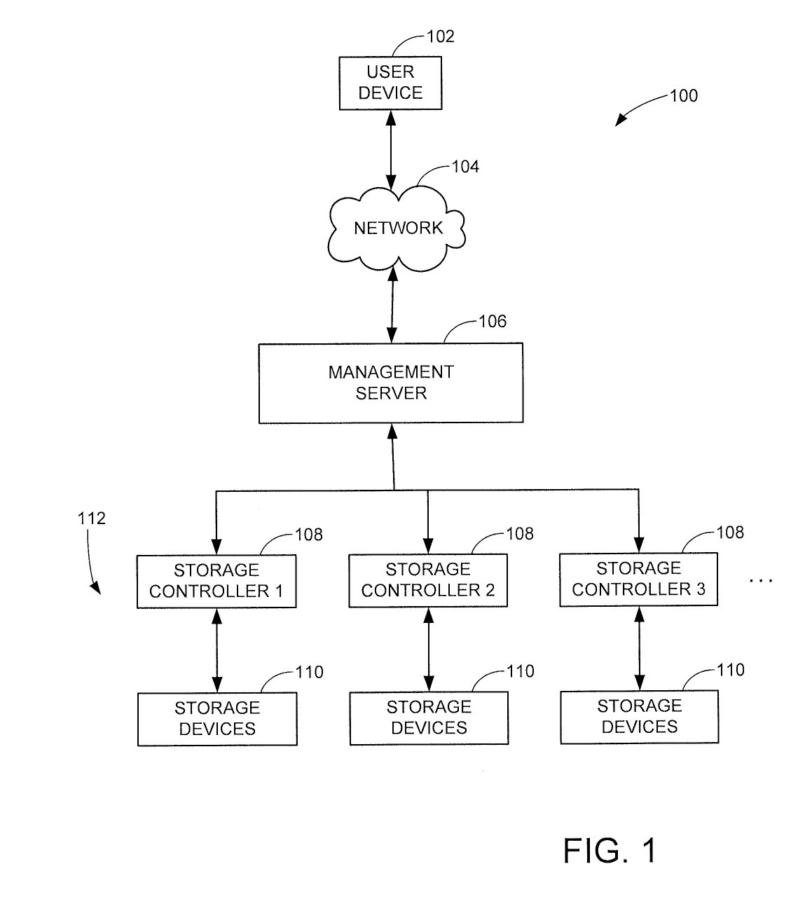

These and various other features of various embodiments disclosed herein can be understood beginning with a review of FIG. 1 which illustrates an object storage system 100. It is contemplated that the system 100 is operated as a subscription-based or private cloud computing network, although such is merely exemplary and not necessarily limiting.

The system 100 is accessed by one or more user devices 102, which may take the form of a network accessible device such as a desktop computer, a terminal, a laptop, a tablet, a smartphone, a game console or other device with network connectivity capabilities. In some cases, each user device 102 accesses the system 100 via a web-based application on the user device that communicates with the system 100 over a network 104. The network 104 may take the form of the Internet or some other computer-based network.

The system 100 includes various elements that may be distributed over a large area. These elements include one or more management servers 106 which process communications with the user devices 102 and perform other system functions. A plurality of storage controllers 108 control local groups of storage devices 110 used to store data objects from the user devices 102, and to return the data data objects as requested. Each grouping of storage devices 110 and associated controller 108 is characterized as a storage node 112.

While only three storage nodes 112 are illustrated in FIG. 1, it will be appreciated that any number of storage nodes can be provided in, and/or added to, the system. It is contemplated that each storage node constitutes one or more zones. Each zone is a physically separated storage pool configured to be isolated from other zones to the degree that a service interruption event, such as a loss of power, that affects one zone will not likely affect another zone. A zone can take any respective size such as an individual storage device, a group of storage devices, a server cabinet of devices, a group of server cabinets or an entire data center. The system 100 is scalable so that additional controllers and/or storage devices can be added to expand existing zones or add new zones to the system.

Generally, data presented to the system 100 by the users of the system are organized as data objects, each constituting a cohesive associated data set (e.g., a file) having an object identifier (e.g., a “name” or “category”). Examples include databases, word processing and other application files, graphics, A/V works, web pages, games, executable programs, etc. Substantially any type of data object can be stored depending on the parametric configuration of the system.

Each data object presented to the system 100 will be subjected to a system replication policy so that multiple copies of the data object are stored in different zones. It is contemplated albeit not required that the system nominally generates and stores three replicas of each data object. This enhances data reliability, but generally increases background overhead processing to maintain the system in an updated state.

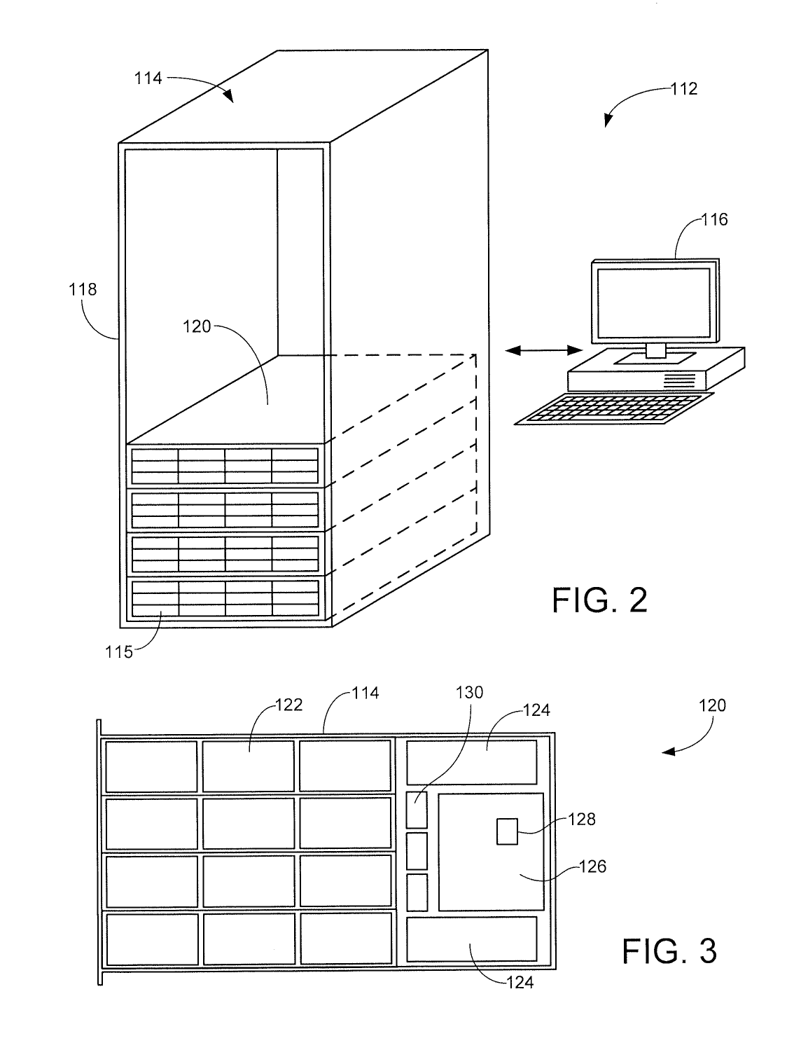

An example hardware architecture for portions of the system 100 is represented in FIG. 2. Other hardware architectures can be used. Each storage node 112 from FIG. 1 includes a storage assembly 114 and a computer 116. The storage assembly 114 includes one or more server cabinets (or storage racks) 118 with a plurality of modular storage enclosures 120.

In some cases, the functionality of the storage controller 108 can be carried out using the local computer 116. In other cases, the storage controller functionality carried out by processing capabilities of one or more of the storage enclosures 120, and the computer 116 can be eliminated or used for other purposes such as local administrative personnel access. In one embodiment, each storage node 112 from FIG. 1 incorporates four adjacent and interconnected storage assemblies 114 and a single local computer 116 arranged as a dual (failover) redundant storage controller.

An example configuration for a selected storage enclosure 120 is shown in FIG. 3. The enclosure 120 incorporates 36 (3×4×3) data storage devices 122. Other numbers of data storage devices 122 can be incorporated into each enclosure. The data storage devices 112 can take a variety of forms, such as hard disc drives (HDDs), solid-state drives (SSDs), hybrid drives (Solid State Hybrid Drives, SSDHDs), etc. Each of the data storage devices 112 includes associated storage media to provide main memory storage capacity for the system 100. Individual data storage capacities may be on the order of some number of terabytes, TB (4×10¹² bytes), per device, or some other value. Devices of different capacities, and/or different types, can be used in the same node and/or the same enclosure. Each storage node 112 can provide the system 100 with several petabytes, PB (10¹⁵ bytes) of available storage, and the overall storage capability of the system 100 can be several exabytes, EB (10¹⁸ bytes) or more, in some embodiments.

In the context of an HDD, the storage media may take the form of one or more axially aligned magnetic recording discs which are rotated at high speed by a spindle motor.

Data transducers can be arranged to be controllably moved and hydrodynamically supported adjacent recording surfaces of the storage disc(s). While not limiting, in some embodiments the storage devices 122 are 3½ inch form factor HDDs with nominal dimensions of 5.75 in ×4 in ×1 in. or 2½ inch form factor HDDs with nominal dimensions of 100 mm×70 mm×7 or 9.5 mm.

In the context of an SSD, the storage media may take the form of one or more flash memory arrays made up of non-volatile flash memory cells. Read/write/erase circuitry can be incorporated into the storage media module to effect data recording, read back and erasure operations. Other forms of solid state memory can be used in the storage media including magnetic random access memory (MRAM), resistive random access memory (RRAM), spin torque transfer random access memory (STRAM), phase change memory (PCM), in-place field programmable gate arrays (FPGAs), electrically erasable electrically programmable read only memories (EEPROMs), etc.

In the context of a hybrid (SSHD) device, the storage media may take multiple forms such as one or more rotatable recording discs and one or more modules of solid state non-volatile memory (e.g., flash memory, etc.). Other configurations for the storage devices 122 are readily contemplated, including other forms of processing devices besides devices primarily characterized as data storage devices, such as computational devices, circuit cards, etc. that at least include computer memory to accept data objects or other system data.

The storage enclosures 120 include various additional components such as power supplies 124, a control board 126 with programmable controller (CPU) 128, fans 130, etc. to enable the data storage devices 122 to store and retrieve user data objects.

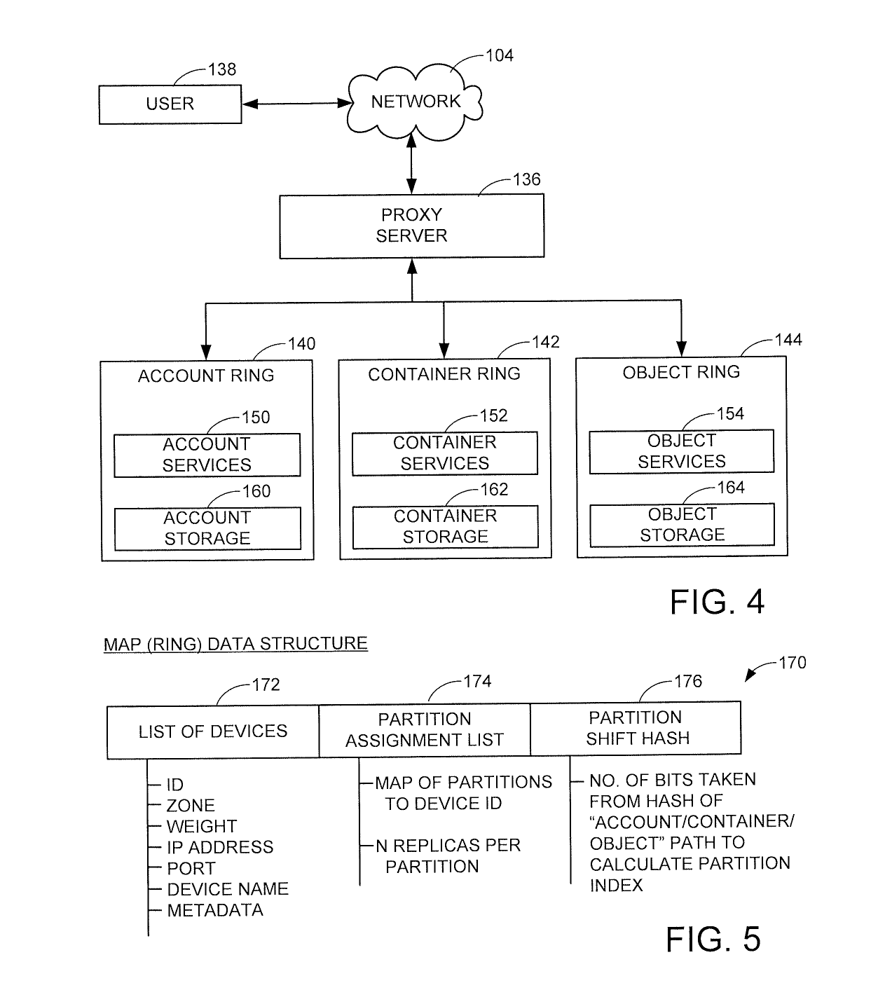

An example software architecture of the system 100 is represented by FIG. 4. As before, the software architecture set forth by FIG. 4 is merely illustrative and is not limiting. A proxy server 136 may be formed from the one or more management servers 106 in FIG. 1 and operates to handle overall communications with users 138 of the system 100 via the network 104. It is contemplated that the users 138 communicate with the system 100 via the user devices 102 discussed above in FIG. 1.

The proxy server 136 accesses a plurality of map structures, or rings, to control data flow to the respective data storage devices 112 (FIG. 3). The map (ring) structures include an account ring 140, a container ring 142 and an object ring 144. Other forms of rings can be incorporated into the system as desired. Generally, each ring is a data structure that maps different types of entities to locations of physical storage. Each ring generally takes the same overall format, but incorporates different hierarchies of data. The rings may be stored in computer memory and accessed by an associated processor during operation.

The account ring 140 provides lists of containers, or groups of data objects owned by a particular user (“account”). The container ring 142 provides lists of data objects in each container, and the object ring 144 provides lists of data objects mapped to their particular storage locations.

Each ring 140, 142, 144 has an associated set of services 150, 152, 154 and storage 160, 162, 164. The services and storage enable the respective rings to maintain mapping using zones, devices, partitions and replicas. The services may be realized by software, hardware and/or firmware. In some cases, the services are software modules representing programming executed by an associated processor of the system.

As discussed previously, a zone is a physical set of storage isolated to some degree from other zones with regard to disruptive events. A given pair of zones can be physically proximate one another, provided that the zones are configured to have different power circuit inputs, uninterruptable power supplies, or other isolation mechanisms to enhance survivability of one zone if a disruptive event affects the other zone. Contrawise, a given pair of zones can be geographically separated so as to be located in different facilities, different cities, different states and/or different countries.

Devices refer to the physical devices in each zone. Partitions represent a complete set of data (e.g., data objects, account databases and container databases) and serve as an intermediate “bucket” that facilitates management locations of the data objects within the cluster. Data may be replicated at the partition level so that each partition is stored three times, one in each zone. The rings further determine which devices are used to service a particular data access operation and which devices should be used in failure handoff scenarios.

In at least some cases, the object services block 154 an include an object server arranged as a relatively straightforward blob server configured to store, retrieve and delete objects stored on local storage devices. The objects are stored as binary files on an associated file system. Metadata may be stored as file extended attributes (xattrs). Each object is stored using a path derived from a hash of the object name and an operational timestamp Last written data always “wins” in a conflict and helps to ensure that the latest object version is returned responsive to a user or system request. Deleted objects are treated as a 0 byte file ending with the extension “.ts” for “tombstone.” This helps to ensure that deleted files are replicated correctly and older versions do not inadvertently reappear in a failure scenario.

The container services block 152 can include a container server which processes listings of objects in respective containers without regard to the physical locations of such objects. The listings may be as SQLite database files or some other form, and are replicated across a cluster similar to the manner in which objects are replicated. The container server may also track statistics with regard to the total number of objects and total storage usage for each container.

The account services block 150 may incorporate an account server that functions in a manner similar to the container server, except that the account server maintains listings of containers rather than objects. To access a particular data object, the account ring 140 is consulted to identify the associated container(s) for the account, the container ring 142 is consulted to identify the associated data object(s), and the object ring 144 is consulted to locate the various copies in physical storage. Commands are thereafter issued to the appropriate storage node 112 (FIGS. 2-3) to retrieve the requested data objects.

Additional services may be incorporated by or used in conjunction with the account, container and ring services 150, 152, 154 of FIG. 4. Such services may be realized as software, hardware and/or firmware. In some cases, the services represent programming steps stored in memory and executed by one or more programmable processors of the system.

The system services can include replicators, updaters, auditors and a new storage management module. Generally, the replicators attempt to maintain the system in a consistent state by comparing local data with each remote copy to ensure all are at the latest version. Object replication can use a hash list to quickly compare subsections of each partition, and container and account replication can use a combination of hashes and shared high water marks.

The updaters attempt to correct out of sync issues due to failure conditions or periods of high loading when updates cannot be timely serviced. The auditors crawl the local system checking the integrity of objects, containers and accounts. If an error is detected with a particular entity, the entity is quarantined and other services are called to rectify the situation.

As explained below, the new storage management module carries out a variety of related functions responsive to the addition of new storage to the system. As used herein, the addition of new storage to the system can refer to (1) the replacement of an existing storage entity that has failed with a new, replacement storage entity; or (2) an expansion of the storage capacity of the storage cluster so that a larger number of storage entities are now in the system, thereby increasing the overall data storage capacity of the system.

With regard to the replacement of an existing storage entity that has failed, it will be appreciated that storage entities can be subjected to a failure condition from time to time and therefore require replacement. This is in contrast to temporary conditions, such as power outages, natural disasters, etc. where existing storage entities are simply “off-line” for a period of time but are subsequently brought back “on-line” after a service interruption and operate as before. Such storage entities can take a variety of hierarchical levels from individual drives 120, sets of drives, entire storage enclosures 120, sets of storage enclosures, entire storage assemblies 114 (storage cabinets), entire storage nodes, sets of storage nodes, and (in unlikely cases) an entire data center.

In the case of a temporary “off-line” situation, the new storage management module may or may not be involved. The replication of data objects within the system is intended to accommodate the temporary unavailability of two out of the three replicated sets, so in such cases normal processing may be carried out to continue data servicing until the off-line situation is corrected.

In the case of an actual failure event, the failed entity can be replaced with a new, replacement entity. For example, a data storage device 122 (e.g., HDD) may experience a failure condition and system administrative personnel may remove the failed HDD and replace it with a new, replacement HDD. Even if the new HDD has a larger storage capacity than the previous HDD (e.g., a 2 terabyte, TB (2×10¹² bytes) drive is replaced by a 4 TB drive), the above described system services such as the replicators, updaters and auditors can operate to “reinstall” the data images from the failed entity onto the new, replacement entity without changes to the system mapping. In such case, the new storage management module may or may not be involved in such routine maintenance operations.

With regard to the provision of new storage capacity to the system, new storage entities can generally be supplied to expand the storage capacity of an existing storage node, or to add one or more new storage nodes to the system. In both cases, the new storage management module operates to detect the new storage entity or entities that have been added to the system, and to carry out data migration operations to redistribute data objects within the system to take advantage of the increase in overall available data capacity. Such data migration operations will generally tend to involve changes to the mapping (ring) structure(s) of the system.

FIG. 5 provides an exemplary format for a selected map data structure 170 in accordance with some embodiments. While not necessarily limiting, the format of FIG. 5 can be utilized by each of the account, container and object rings 140, 142, 144 of FIG. 4.

The map data structure 180 is shown to include three primary elements: a list of devices 172, a partition assignment list 174 and a partition shift hash 176. The list of devices (devs) 172 lists all data storage devices 122 that are associated with, or that are otherwise accessible by, the associated ring, such as shown in Table 1.

TABLE 1

| Data Value | Type | Description |
|---|---|---|
| ID | Integer | Index of the devices list |
| ZONE | Integer | Zone in which the device resides |
| WEIGHT | Floating | Relative weight of the device capacity |
| IP ADDRESS | String | IP address of storage controller of device |
| TCP PORT | Integer | TCP port for storage controller of device |
| DEVICE | String | Device name |
| METADATA | String | General use field for control information |

Generally, ID provides an index of the devices list by device identification (ID) value. ZONE indicates the zone in which the data storage device is located. WEIGHT indicates a relative weight factor of the storage capacity of the device relative to other storage devices in the system. For example, a 2 TB (terabyte, 10¹² bytes) drive may be given a weight factor of 2.0, a 4 TB drive may be given a weight factor of 4.0, and so on.

IP ADDRESS is the IP address of the storage controller associated with the device. TCP PORT identifies the TCP port the storage controller uses to serve requests for the device. DEVICE NAME is the name of the device within the host system, and is used to identify the disk mount point. METADATA is a general use field that can be used to store various types of arbitrary information as needed.

The partition assignment list 174 generally maps partitions to the individual devices. This data structure is a nested list: N lists of M+2 elements, where N is the number of replicas for each of M partitions. In some cases, the list 174 may be arranged to list the device ID for the first replica of each M partitions in the first list, the device ID for the second replica of each M partitions in the second list, and so on. The number of replicas N is established by the system administrators and may be set to three (e.g., N=3) or some other value. The number of partitions M is also established by the system administrators and may be a selected power of two (e.g., M=2²⁰, etc.).

The partition shift value 176 is a number of bits taken from a selected hash of the “account/container/object” path to provide a partition index for the path. The partition index may be calculated by translating a binary portion of the hash value into an integer number.

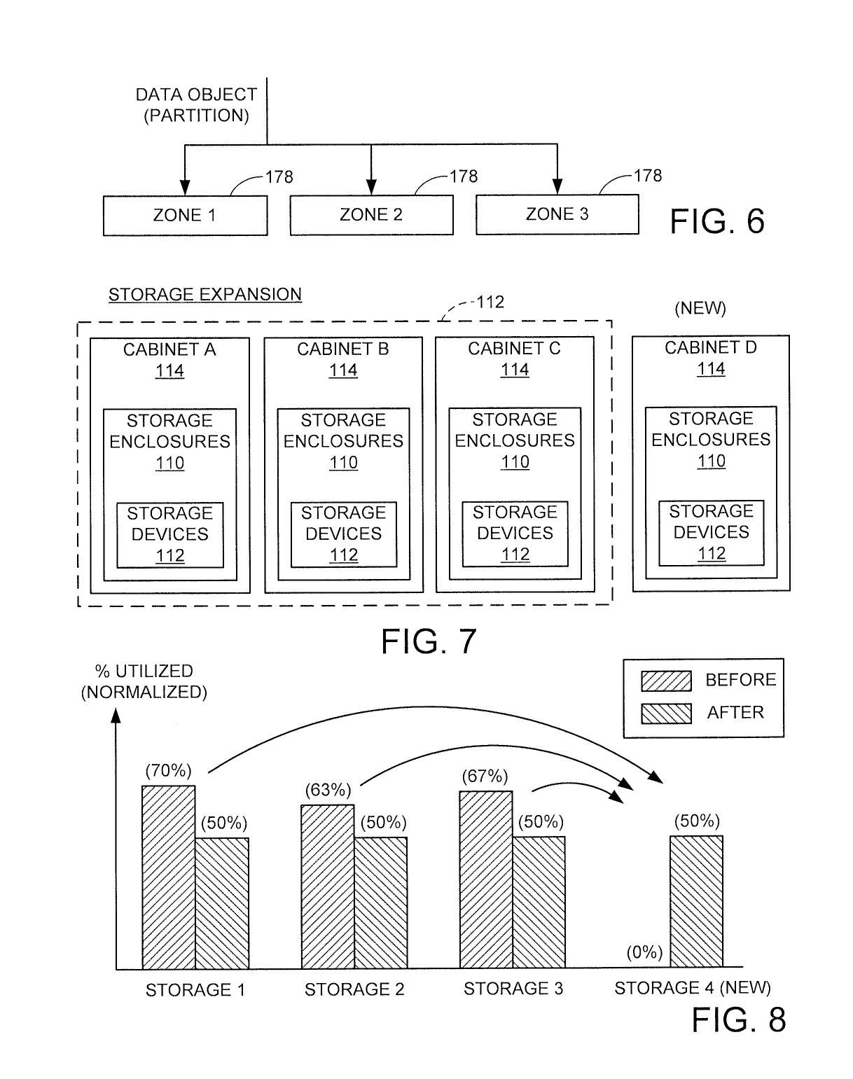

FIG. 6 shows the distribution of data objects (partitions) among different zones 178. As discussed above, the zones 178 represent different storage locations within the system 100 for the storage of replicated data. While not necessarily limiting, the zones are generally intended to be physically and/or functionally separated in a manner sufficient to reduce a likelihood that a disruptive event affecting one z one will not necessarily affect another zone. For example, separate uninterruptable power supplies or other electrical circuits may be applied to different storage entities in different zones but otherwise physically proximate one another. Alternatively, the zones may be physically remote one from another, including in different facilities, cities, states and/or countries.

To service an access request upon the data objects stored in FIG. 6, a user access command may be issued by a user 138 to the proxy server 136 (FIG. 4) to request a selected data object. In some embodiments, the command may be in the form of a URL such as https://swift.example.com/v1/account/container/object, so that the user supplies account, container and/or object information in the request. The account, container and object rings 140, 142, 144 (FIG. 4) may be referenced by the proxy server 136 to identify the particular storage device 122 (FIG. 3) from which the data object should be retrieved.

The access command is forwarded to the associated storage node, and the local storage controller 108 (FIG. 1) schedules a read operation upon the associated storage device(s) 122. In some cases, system services may determine which replicated set of the data should be accessed to return the data (e.g., which zone 178 in FIG. 6). The data objects (retrieved data) are returned from the associated device and forwarded to the proxy server which in turn forwards the requested data to the user device 138.

FIG. 7 presents an example in which new storage is added to an existing storage node 112. It will be appreciated that FIG. 7 is merely illustrative and not limiting. The storage node 112 includes a storage controller (not separately shown in FIG. 7) and three storage cabinets 114 identified as Cabinet A, Cabinet B and Cabinet C. Each of the storage cabinets 114 include a plurality of storage enclosures 120 (FIG. 2), and each of the storage enclosures 120 include a plurality of storage devices 122 (FIG. 3). In some cases, each of the cabinets 114 will constitute a different zone as in FIG. 6. In other cases, each of the cabinets 114 are associated with the same zone. For reference, the storage devices in the respective cabinets 114 can be characterized as a first set of data storage devices which provide a first overall amount of data storage capacity, and the first set of storage devices are arranged into N subgroups (e.g., N=3, one subgroup per cabinet).

A new, fourth cabinet 114 is shown in FIG. 7 (“Cabinet D”). It is contemplated albeit not necessarily required that the overall storage capacity of each of the Cabinets A-D is the same. The addition of Cabinet D nominally increases the overall storage capacity of the storage node 112 by about 33%. While storage may be added for a variety of reasons, it is contemplated that the addition of the new storage is due to a relatively high utilization rate of the existing three Cabinets A-C. In some cases, the storage devices in Cabinet D can be characterized as a second set of storage devices and viewed as an additional subgroup so that the total number of subgroups is incremented to N+1 (e.g., N=4, one subgroup per cabinet as before).

Generally, the addition of the new storage entity (Cabinet D) to the storage node 112 results in the automated detection of the new storage, and in response thereto, the automated migration of some of the data from each of the existing entities (Cabinets A-C) to the new entity (Cabinet D), and the automated generation of a new map structure. The new map structure can be generated prior to, or after, the data migration, as discussed below.

FIG. 8 provides a generalized representation of data migration from three existing storage subgroups (Storage 1-3) to incorporate a fourth, new storage subgroup (Storage 4). These may correspond to the respective Cabinets A-D in FIG. 7, or to some other storage entities at any desired hierarchical level.

Prior to the data migration, it can be seen that Storage 1 has a normalized utilization of about 70%, which means that only about 30% of the overall storage capacity of the entity is available to accommodate the storage of new data objects. Storage 2 has a normalized utilization of about 63% and Storage 3 has a normalized utilization of about 67%.

Once added to the system, Storage 4 receives a portion of the data stored in each of the first three entities Storage 1-3 so that all four of the storage entities have a nominally equal storage utilization, e.g., about 50%. It will be appreciated that the actual amounts of data migrated will be at object/partition boundaries, and various other considerations (including zoning) may come into play so that the final utilization distribution may not be equal across all of the devices. Nevertheless, the addition of the new storage capacity to the system operates to reduce the utilization of the existing entities and balance the amount of storage among the first and second sets of storage devices.

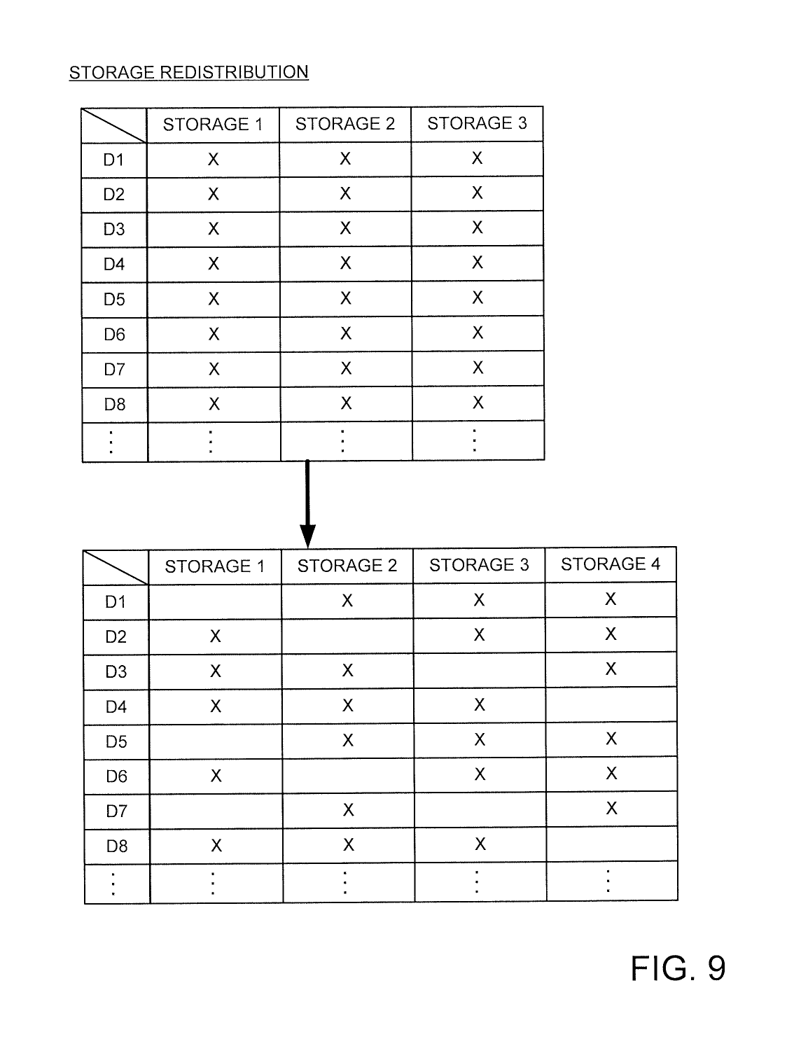

FIG. 9 illustrates exemplary data migrations among the various entities of FIG. 8. A first data distribution table 180 shows data object sets D1-D8 that are stored on entities Storage 1-3. In some cases, each storage entity may be a separate zone so that the data are replicated on all three entities. In other cases, portions of the respective data object sets are stored to the respective entities (e.g., each “X” represents a different group of data objects).

A second data distribution table 190 shows the data object sets D1-D8 after the data migration operation. It can be seen that some data object sets have been distributed to the available storage in the Storage 4 entity. A regular pattern of distribution can be applied, as represented in FIG. 9. For example, for data object set D1, the data (“X”) stored in Storage 1 is moved to Storage 4; for D2, the data in Storage 2 is moved to Storage 4, and so on. This pattern can be repeated until all data sets have been moved.

In other cases, the data object sets D1-D8 can be sorted by size and the largest sets of data can be migrated first. In still other cases, a predetermined threshold can be assigned to the new storage (e.g., 40% utilization, etc.) and data migrations continue until the predetermined threshold is reached.

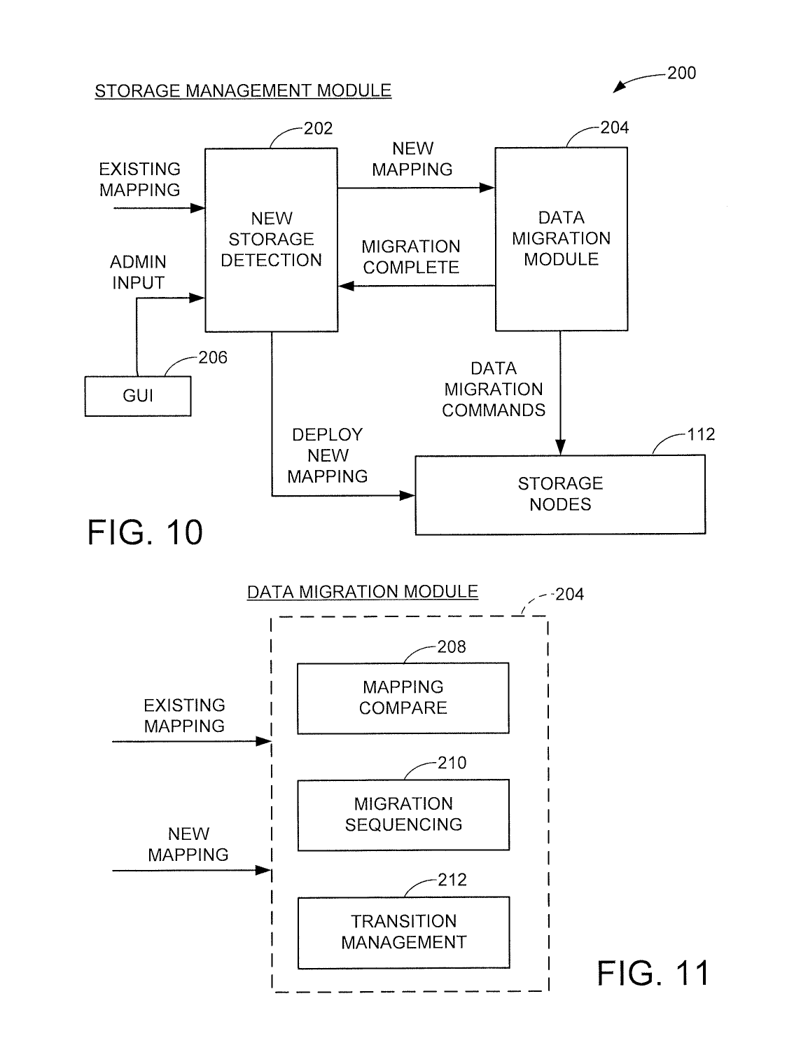

FIG. 10 is a functional block representation of a storage management module 200 adapted to carry out data expansion operations such as discussed above in FIGS. 7-9. The storage management module 200 includes a new storage detection block 202 and a data migration module 204. The new storage detection block 202 automatically detects the addition of new storage to the system, and generates new mapping for the system. The data migration module 204 directs the migration of data in response to the new mapping. The functionality of these respective blocks can be realized at each storage controller node in the form of software executable at each node, or at a higher level management server 106 (see FIG. 1) that communicates with each of the storage controllers 108.

In some embodiments, the new storage detection block 202 operates in a plug-and-play manner to automatically detect the addition of new hardware and/or software applications. For example, the connecting of a new storage cabinet 114 as in FIG. 7 to the local storage controller 108 may result in the reporting by the storage controller to the new storage detection block 202 of the new available capacity. The devices can be individually identified and entered by a system administrator via a graphical user input (GUI) 206, or the storage controller can poll the new devices to discover the number of devices, to determine the individual capacities of the devices, to assign or discover names for the individual devices, etc.

The new storage detection block 202 further operates to obtain existing mapping of the system and to generate new mapping that takes into account the additional capacity supplied by the new storage entities. In some cases, the data migration necessary to conform to the new mapping can take place prior to the deployment of the new mapping, so that the data migration is carried out “in the background” by the system. This approach is suitable for use, for example, when additional storage capacity is provided to a particular storage node and the additional capacity is going to be locally used by that node as opposed to significant transfers of data from other nodes to the new capacity.

When the data are migrated prior to mapping deployment, the data objects will already be stored in locations that substantially conform to the newly promulgated maps. In this way, other resources of the system such as set forth in FIG. 4 will not undergo significant operations in an effort to migrate the data and conform the system to the new mapping. Issues such as maintaining the ability to continue to service ongoing access commands during the data migration process are readily handled by the module 200. It is contemplated that all of the map structures (account, container and object) may be updated concurrently, but in some cases only a subset of these map structures may require updating (e.g., only the object ring, etc.).

The new storage detection module 202 proceeds to generate a new map structure (“new mapping”), and supplies such to the data migration module 204. The map builder module 202 may further supply the existing mapping to the data migration module 204. As further depicted in FIG. 11, a mapping compare block 208 of the data migration module 204 determines which data objects require migration. This can be carried out in a variety of ways, but will generally involve a comparison between the existing mapping and the new mapping. This is because, in the present example the new mapping remains localized and has not yet been deployed to all storage nodes.

A migration sequencing block 210 schedules and directs the migration of data objects within the storage nodes 112 to conform the data storage state to the new mapping. This may include the issuance of various data migration commands to the respective storage nodes 112 in the system, as represented in FIG. 10.

In response to the data migration commands, various data objects may be read, temporarily stored, and rewritten to different ones of the various entities in the storage node(s). It is contemplated that a substantial portion of the migrated data objects will be migrated from the “old” entities to the “new” entities, although for balancing purposes the data objects may also be moved between the old entities as well. The migration sequencing block 210 may receive command complete status indications from the node(s) signifying the status of the ongoing data migration effort.

It will be noted that while the data are being migrated, the data state will be intentionally placed in a condition where it deviates from the existing map structures of the respective nodes. In some cases, a transition management block 212 may communicate with other services of the system (e.g., the replicators, updaters, auditors, etc.) to suspend the operation of these and other system/ring services to not attempt to “undo” the migrations. An exception list, for example, may be generated and issued for certain data objects so that, should one or more of these services identify a mismatch between the existing mapping and the actual locations of the respective data objects, no corrective action will be taken. In other cases, the storage nodes affected by the data migrations may be temporarily marked as “off limits” for actions by these and other services until the completion of the migration. In still further embodiments, a special data migration command may be issued so that the storage controllers are “informed” that the migration commands are in anticipation of new mapping and therefore are intentionally configured to “violate” the existing mapping.

Once the data migration is complete, a migration complete status may be generated by the data migration module 204 and forwarded to the new storage detection block 202. Upon receipt of the migration complete status, the block 202 deploys the new mapping by forwarding new map structures to the various storage nodes in the system. At this point the data state of the system should nominally match that of the new map structures, and little if any additional overhead processing should be required by other system services to ensure conformance of the system to the newly deployed map structure(s).

Another issue that may arise from this processing is the handling of data access commands during the data migration process to accommodate the new storage. Depending on the size of the additional capacity added to the system, the processing depicted in FIG. 10 will often be completed in a relatively short period of time. Nevertheless, a data access command may be received from a user for data objects affected by the data migration carried out by the data migration module 204.

In such case, the migration sequencing block 210 may be configured to intelligently select the order in which data objects are migrated and/or “tombstoned” during the migration process. As the system maintains multiple replicas of every set of data objects (e.g., N=3), in some cases at least one set of data objects are maintained in an existing mapping structure so that data access commands can be issued to those replica sets of the data objects not affected by the migration. In some cases, these pristine replicas can be denoted as “source” replicas so that any access commands received during the data migration process are serviced from these replicas.

Additionally or alternatively, a temporary translation table can be generated so that, should the objects not be found using the existing mapping, the translation table can be consulted and a copy of the desired data objects can be returned from a cached copy and/or from the new location indicated by the new mapping.

While it is contemplated that the mapping will be deployed prior to data migration, such is not necessarily required. In an alternative embodiment, the new mapping may be generated and deployed by the new storage detection block 202, after which the data migration module 204 operates to conform the data object storage configuration to match the newly promulgated mapping. This latter approach is suitable, for example, when new storage nodes are added to the system. The device list for the new storage entities can be appended to the various ring structures by the new storage detection block 202, and the data migration module 204 can direct the rebalancing operation in an orderly fashion.

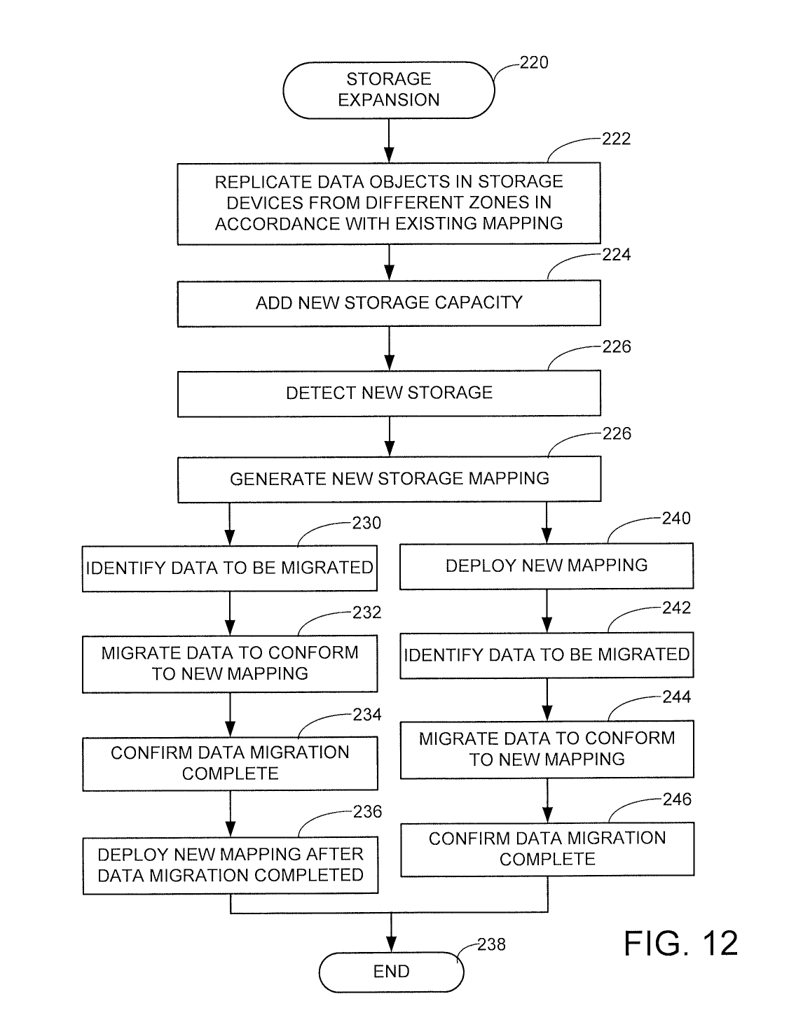

FIG. 12 provides a flow chart for a STORAGE EXPANSION routine 220 illustrative of the foregoing discussion. The routine 200 is merely exemplary and is not limiting. The various steps shown in FIG. 12 can be modified, rearranged in a different order, omitted, and other steps can be added as required.

At step 222, various data objects supplied by users 138 of the system 100 are replicated in storage devices 122 housed in different zones in accordance with an existing mapping structure. The existing mapping structure may include the account, container and object rings 140, 142, 144 discussed above having a format such as set forth in FIG. 5.

At some point during the operation of the system 100, new storage capacity is added to the system, as indicated by step 224. This will involve the connection of one or more new storage entities to the existing system to expand the overall storage capacity. The new storage capacity is detected at step 226 by the new storage detection block 202 of FIG. 10. The new storage detection block 202 further generates new storage mapping that takes into account the newly added storage entities at step 228.

At this point, the routine passes along one of two parallel paths. While either or both paths can be alternately used depending on system requirements, in some embodiments the first path is used when an existing storage node (or other storage pool) is expanded and the second path is used when new storage nodes (or other storage pools) are added to the system.

The first path includes identification at step 230 of the data objects that require migration to conform the system to the new map structure. This may be carried out by the data migration module 204 of FIG. 10, including through the use of the mapping compare block 208 of FIG. 11. The identified data objects are migrated to one or more new locations at step 232, such as through the use of the migration sequencing block 210 of FIG. 11.

Although not shown in FIG. 12, user data access commands received during this processing are serviced as discussed above, with the use of temporary transition tables or other data structures to enable the system to locate and return the requested data objects. New data objects presented for storage during the data transition may be stored in an available location, or may be temporarily cached pending completion of the data migration process. In some cases, newly received data objects may be specifically directed to the newly available storage space to reduce the need to migrate data thereto. Existing system services that normally detect (and attempt to correct) discrepancies between the existing map structures and the actual locations of the objects may be suspended or otherwise instructed to hold off making changes to noted discrepancies.

Once the data migration is confirmed as being completed, step 234, the new map structures are deployed to the various storage nodes and other locations throughout the system at step 236, and the routine ends at step 238.

The second processing path involves deployment of the new storage mapping at step 240. This provides the new ring structures to each of the storage nodes and other operative elements in the system 100. The data migration module 204 proceeds to identify the data to be migrated in order to conform to the new mapping, step 242, the data are migrated at step 244, and as desired a data migration complete status can be generated at step 246.

Depending on the size of the additional storage capacity added to the system, significant amounts of data may be migrated internally in order to conform the system to the new mapping (whether prior to or after map deployment). Accordingly, further embodiments operate to identify the available bandwidth of the system 100 and the amount of data migration is throttled to ensure that sufficient resources are available to service the then-existing user I/O requirements.

The available bandwidth represents the data transfer capacity of the system 100 that is not currently being utilized to service data transfer operations with the users of the system. In some cases, the available bandwidth, B_{AVAIL}, can be determined as follows:

B_{AVAIL}=(C_{TOTAL}−C_{USED})*(1−K) (1)

Where C_{TOTAL} is the total I/O data transfer capacity of the system, C_{USED} is that portion of the total I/O data transfer capacity of the system that is currently being used, and K is a derating (margin) factor. The capacity can be measured in terms of bytes/second transferred between the proxy server 136 and each of the users 138 (see FIG. 4), with C_{TOTAL} representing the peak amount of traffic that could be handled by the system at the proxy server connection to the network 104 under best case conditions, under normal observed peak loading conditions, etc. The capacity can change at different times of day, week, month, etc. Historical data can be used to determine this value.

The C_{USED} value can be obtained by the new storage management module 200 directly or indirectly measuring, or estimating, the instantaneous or average traffic volume per unit time at the proxy server 136. Other locations within the system can be measured in lieu of, or in addition to, the proxy server. Generally, however, it is contemplated that the loading at the proxy server 136 will be indicative of overall system loading in a reasonably balanced system.

The derating factor K can be used to provide margin for both changes in peak loading as well as errors in the determined measurements. A suitable value for K may be on the order of 0.02 to 0.05, although other values can be used as desired. It will be appreciated that other formulations and detection methodologies can be used to assess the available bandwidth in the system.

The available bandwidth B_{AVAIL} may be selected for a particular sample time period T_{N}. The sample time period can have any suitable resolution, such as ranging from a few seconds to a few minutes or more depending on system performance. Sample durations can be adaptively adjusted responsive to changes (or lack thereof) in system utilization levels.

The available bandwidth B_{AVAIL} is provided to the data migration module 204, which selects an appropriate volume of data objects to be migrated during the associated sample time period T_{N}. The volume of data migrated is selected to fit within the available bandwidth for the time period. In this way, the migration of the data will generally not interfere with ongoing data access operations with the users of the system. The process is repeated for each successive sample time period T_{N+1}, T_{N+2}, etc. until all of the pending data have been successfully migrated.

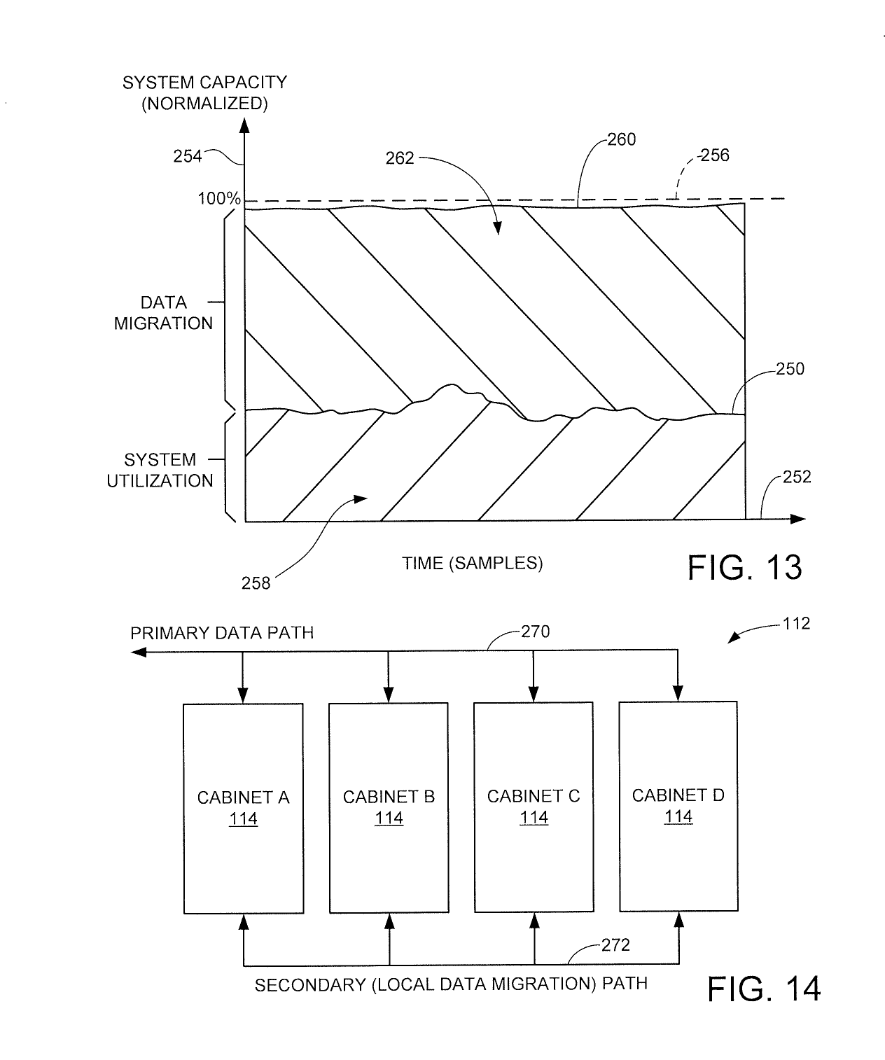

FIG. 13 provides a graphical representation of the foregoing operation of the new storage management module 200 of FIG. 10. A system utilization curve 250 is plotted against an elapsed time (samples) x-axis 252 and a normalized system capacity y-axis 254. Broken line 256 represents the normalized (100%) data transfer capacity of the system (e.g., the C_{TOTAL} value from equation (1) above). The cross-hatched area 258 under curve 250 represents the time-varying system utilization by users of the system 100 (e.g., “user traffic”) over a succession of time periods. In other words, the individual values of the curve 250 generally correspond to the C_{USED} value from equation (1).

FIG. 13 further shows a migration curve 260. The cross-hatched area 262 between curves 250 and 260 represent the time-varying volume of data over the associated succession of time periods that is migrated by the management module 200. The migration curve 260 represents the overall system traffic, that is, the sum of the user traffic and the traffic caused by data migration. The curve 260 lies just below the 100% capacity line 256, and the difference between 256 and 260 results from the magnitude of the derating value K as well as data granularity variations in the selection of migrated data objects.

From a comparison of the relative heights of the respective cross-hatched areas 258, 262 in FIG. 13, it is evident that relatively greater amounts of data are migrated at times of relatively lower system utilization, and relatively smaller amounts of data are migrated at times of relatively higher system utilization. In each case, the total amount of system traffic is nominally maintained below the total capacity of the system.

FIG. 14 illustrates another embodiment of the present disclosure. The respective Cabinets A-D of FIG. 7 are connected via a primary data path 270 and a secondary (local data migration) path 272. The primary data path 270 may represent one or more buses, or collection of buses, that interconnect the associated storage node controller 108 (not separately shown in FIG. 14). Normal data access operations are carried out via the primary data path 270.

The secondary path 272 is a second path between the respective storage devices of the respective storage cabinets 114. As with the primary data path, the secondary path 272 may also be one or more buses that interconnect the various storage enclosures within the cabinets 114 and therefore take the same general form as the primary path 270. Other forms can be used, such as fiber optic, wireless routing, coaxial cables, etc. for the secondary path 272. Suitable hardware (e.g., switches, etc.) and/or software (port control, etc.) may be added to the system to facilitate use of both paths 270, 272.

Generally, the system configuration of FIG. 14 is adapted to allow the ongoing, non-restricted use of the primary path 270 to service user access commands and other commands to migrate and/or otherwise transfer data to and from the respective cabinets 114. In parallel with such operation, the secondary path 272 provides a dedicated pathway within the storage node 112 to migrate data between the respective cabinets 114. In this way, intra-node migrations as depicted in FIGS. 7-9 can be carried out with little or no substantive impact on the primary path 270.

It is contemplated that the secondary path can be permanently affixed to the cabinets 114 and used as a bypass path to migrate data objects between the respective cabinets. Alternatively, the secondary path 272 can be part of a new storage installation kit which is temporarily installed and used to migrate data between the respective cabinets 114, after which the pathway is removed once such migration is complete to accommodate the new Cabinet D.

The systems embodied herein are suitable for use in cloud computing environments as well as a variety of other environments. Data storage devices in the form of HDDs, SSDs and SSHDs have been illustrated but are not limiting, as any number of different types of media and operational environments can be adapted to utilize the embodiments disclosed herein

It is to be understood that even though numerous characteristics and advantages of various embodiments of the present disclosure have been set forth in the foregoing description, together with details of the structure and function of various embodiments thereof, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. An object storage system comprising:
a first set of data storage devices storing data objects in accordance with a first map structure; and
a management module configured to detect a second set of at least one data storage device added to the first set and, in response thereto, generate a second map structure and migrate a portion of the data objects from the first set to the second set based on the second map structure to balance the first and second sets.

2. The object storage system of claim 1, wherein the first set of data storage devices provide a first overall data storage capacity to store and retrieve data objects of users of the object storage system, and the addition of the second set of at least one data storage device provides a larger, second overall data storage capacity to store and retrieve data objects of users of the object storage system.

3. The object storage system of claim 1, wherein the first set of data storage devices are arranged into N subgroups, and wherein a different number of data objects in each of the N subgroups are migrated to the second set of at least one data storage device so that each of the N subgroups and the second set store nominally the same total number of data objects.

4. The object storage system of claim 1, wherein the first map structure correlates the data objects to the respective data storage devices in the first set prior to the migration, and the second map structure correlates the data objects to the respective data storage devices in the first and second set after the migration.

5. The object storage system of claim 1, wherein the management module comprises a new storage detection module adapted to automatically generate the second map structure and a data migration module adapted to automatically migrate data objects to the second set of storage devices to conform the data objects to the second map structure.

6. The object storage system of claim 5, wherein the data migration module comprises a mapping compare block which identifies a set of data objects requiring migration to conform to the second map structure, and a migration sequencing block which issues a succession of data migration commands to a storage controller to migrate the set of data objects to conform to the second map structure, wherein the map builder module transfers a copy of the second map structure responsive to a data migration complete status signal from the data migration module indicating that the set of data objects have been successfully migrated.

7. The object storage system of claim 3, further comprising a transition management block which manages data access operations upon the data objects migrated by the data migration module prior to the issuance of the data migration compete status signal.

8. The object storage system of claim 1, wherein the management module migrates the data objects prior to deployment of the second map structure to a server.

9. The object storage system of claim 1, wherein the management module will receive limited input before generating a second map structure or migrating a portion of the data objects to balance the first and second sets.

10. The object storage system of claim 1, wherein the first set of data storage devices are arranged into a plurality of storage nodes each having an associated storage controller, and the second set of at least one data storage device is added to a selected storage node to expand a total storage capacity of the selected storage node.

11. The object storage system of claim 10, wherein the management module migrates the data objects within the selected node prior to deployment of the second map structure to the storage controllers of the remaining storage nodes.

12. The object storage system of claim 1, further comprising a server adapted to communicate between users of the object storage system and the first set of data storage devices along a primary communication path, and wherein the management module migrates the data objects from the first set of data storage devices to a second set of at least one data storage device along a secondary communication path in parallel to the primary communication path.

13. An object storage system comprising:
a storage controller having a processor and memory;
a plurality of storage devices connected to the storage controller to form a storage node, the storage devices arranged into N subgroups, wherein data objects are stored in the N subgroups based on a first map structure stored in the storage controller memory; and
a management module which automatically detects an additional plurality of storage devices connected to the storage controller to provide N+1 subgroups, migrates a portion of the data objects in each of the N subgroups to the additional plurality of storage devices, generates a second map structure to describe the data objects stored in the N+1 subgroups, and stores the second map structure in the storage controller memory.

14. The object storage system of claim 13 further comprising a plurality of additional storage nodes each comprising a storage controller with a processor and memory and a plurality of storage devices associated with the storage controller, wherein the management module further operates to transfer a copy of the second map structure to each of the additional storage nodes for storage in the associated storage controller memory of the node.

15. The object storage system of claim 13, wherein the management module comprises a new storage detection module adapted to generate the second map structure and a data migration module adapted to migrate data objects to the second set of storage devices to conform the data objects to the second map structure.

16. A computer implemented method comprising:
storing data objects in a first set of data storage devices of an object storage system in accordance with a first map structure stored in a memory;
connecting a second set of data storage devices to the first set; and
detecting the connection of the second set to the first set, and in response thereto, generating a second map structure and migrating a portion of the data objects from the first set to the second set based on the second map structure to rebalance the first and second sets.

17. The method of claim 16, wherein the first set of data storage devices provide a first overall data storage capacity to store and retrieve data objects of users of the object storage system, and the addition of the second set of data storage devices provides a larger, second overall data storage capacity to store and retrieve data objects of users of the object storage system.

18. The method of claim 16, wherein the first set of data storage devices are arranged into N subgroups, and wherein a different number of data objects in each of the N subgroups are migrated to the second set of data storage devices so that each of the N subgroups and the second set store nominally the same total number of data objects.

19. The method of claim 16, wherein the first set of data storage devices are associated with a selected storage node in the object storage system having a storage controller, wherein the detecting step is carried out by a management module having a new storage detection module which detects the connection of the second set, a new map generation module which generates the second map structure, and a data migration module which migrates the data objects from the first set to the second set.

20. The method of claim 16, wherein the object storage system further comprises a proxy server which processes data transfers between the selected storage node and users of the object storage system, and wherein the management module further operates to detect an available bandwidth of the proxy server and to transfer the data objects to the second set so as to fall within the detected available bandwidth.
